(19) United States
(12) Patent Application Publication
(10) Pub. No.: US 2014/0032917 A1
(43) Pub. Date: Jan. 30, 2014

(54) GROUP SIGNATURE PROCESSING DEVICE FOR PROCESSING A PLURALITY OF GROUP SIGNATURES SIMULTANEOUSLY

(71) Applicant: Sumio Morioka, Minato-ku (JP)

(72) Inventor: Sumio Morioka, Minato-ku (JP)

(73) Assignee: NEC CORPORATION, Tokyo (JP)

(21) Appl. No.: 13/881,537

(22) PCT Filed: May 30, 2011
(86) PCT No.: PCT/JP2011/003006

§ 371 Date: Oct. 15, 2013

(30) Foreign Application Priority Data
Oct. 29, 2010 (JP) 2010-243321

(51) Int. Cl. H04L 29/06

(52) U.S. Cl. CPC H04L 63/0428
USPC 713/176

(57) ABSTRACT

A plurality of group signature processes is executed in parallel with a small number of processing devices and small power consumption, without lowering an average response speed. A signature processing device includes subsystems for each type of basic operations included in a signature processing procedure. Each subsystem has a configuration in which one or more basic operation execution units and a dispatcher that monitors operation states thereof and instructs to execute an operation are interconnected. A plurality of signature generation requests or signature verification requests is accepted as a single input, and a plurality of requests is simultaneously processed in parallel. At this time, each subsystem assigns operations in different requests to unoccupied basic operation units and causes the basic operation units to simultaneously execute the operations, without being occupied with a single request.

### TECHNICAL FIELD

The present invention relates to a signature processing device, and more particularly, to a group signature processing device that processes a plurality of group signatures simultaneously.

### BACKGROUND ART

In recent years, group signature technology has been proposed in the fields of cryptography and signature. The group signature technology is a technology for verification as to whether a signer belongs to a group. The signer can remain anonymous as a member within the group. However, an authority can revoke the anonymity of a member as needed, to thereby prevent abuse of the anonymity.

The group signature technology is disclosed in the below-mentioned literatures (Patent Literature 1 and Non Patent Literatures 1 to 3), for example. Non Patent Literature 1 discloses a basic algorithm for generating and verifying group signatures. Non Patent Literature 1 also discloses a circuit having a small size and capable of processing group signatures at high speed.

Further, Patent Literature 1 discloses a signature processing device. In Patent Literature 1, as shown in FIG. 13, a signature processing device 300 includes an elliptic curve operation unit 301, a remainder operation unit 302, a pseudo-random number generation unit 303, an integer operation unit 305, and a hash operation unit 306. These units are connected via a low-bandwidth bus.

Incidentally, the group signature devices disclosed in these literatures target portable mobile devices and the like that are used by a single user, but are not assumed to be used for devices used by a plurality of users simultaneously. However, as shown in FIG. 13, not only a terminal used by an individual user, but also a server of a wide-area data center accessed by a number of users simultaneously, for example, is required to execute a signature process. In this case, there is a need for executing a plurality of signature processes simultaneously.

In the case where multiple processing requests are generated simultaneously, the generated requests are, in general, sequentially input into a cue and successively processed by a processor or the like in general. Such a processing system is often used in a common key cryptographic operation and a public key cryptographic operation.

However, it takes 0.1 to several seconds to execute one process for a group signature. Accordingly, if requested processes are successively carried out in the process of group signatures for a plurality of users, there are such problems that an average response time significantly deteriorates and a sensory speed of service provision is lowered.

In this case, in order to maintain the average response time of group signatures for a plurality of users at the same level as that of a single signature, preparing a number of signature processing devices corresponding to the number of requests to process the requests in parallel as shown in FIG. 14 is considered as a typical solution.

### CITATION LIST

### Patent Literature

[Patent Literature 1] Japanese Unexamined Patent Application Publication No. 2010-014912
[Patent Literature 2] Japanese Unexamined Patent Application Publication No. 2006-243690
[Patent Literature 3] Japanese Unexamined Patent Application Publication No. 2007-234001
[Patent Literature 4] Published Japanese Translation of PCT International Publication for Patent Application, No. 2009-500710

### Non Patent Literature

[Non Patent Literature 1] Sumio Morioka, Toshinori Araki, Toshiyuki Isshiki, Satoshi Obana, Kazue Sako, “ASIC implementation of a group signature algorithm using two-level behavioral synthesis”, The Institute of Electronics, Information and Communication Engineers, VLSI conference, VLD2009-128, pp. 175-180, 2010
[Non Patent Literature 2] J. Camenish and J. Groth, “Group signatures: Better efficiency and new theoretical aspects”, SCN2004, LNCS Vol. 3352, pp. 120-133, 2004.
[Non Patent Literature 3] T. Isshiki, K. Mori, K. Sako, I. Teranishi, and S. Yonezawa, “Using Group Signature for Identity Management and its Implementation”, DIM2006, 2006.

### SUMMARY OF INVENTION

### Technical Problem

However, when the signature processing devices are multiplied to handle N number of requests, the cost increases N-fold. Also in the case where a signature process is executed by an LSI circuit or program processing, when the process is simply multiplied, the chip area of the LSI circuit increases N-fold and the number of processors for the program processing increases N-fold. Along with this, the power consumption also increases N-fold.

For example, in the case of server devices installed in a wide-area data center, the number of the devices directly affects the facility cost and operational cost. Furthermore, an increase in power consumption makes it difficult to control the temperature of each device.

Accordingly, in the process of group signatures for a plurality of users, it is desirable to process a number of requests simultaneously with as few devices as possible, without deteriorating the average response time for the signature process. This also holds true for the case where the signature process is executed by an LSI circuit or program.

It is an object of the present invention to provide a signature generation device and a signal verification device, which are capable of executing a number of signal processes while suppressing an increase rate of power consumption and an increase rate of a circuit size, without lowering an average response speed of the signature processes.

### Solution to Problem

In a signature processing device according to the present invention, configured are subsystems for each type of basic operations included in a signature processing procedure,

each of the subsystems having one or more basic operation execution units and a dispatcher that monitors operation states thereof and instructs to execute an operation, and

the basic operation execution units and the dispatcher being interconnected, wherein the plurality of subsystems is connected through a buffer memory that relays an operation request.

A signature processing method according to the present invention includes:

simultaneously executing, by one or more basic operation execution units, basic operations included in a signature processing procedure;

monitoring an operation state and instructing acceptable basic operation execution units to sequentially execute operations; and

assigning operations in different requests to the respective basic operation units and causing the basic operation units to simultaneously execute the operations without being occupied with a single request.

A recording medium according to the present invention causes a computer including a plurality of processors to:

function as a subsystem for each type of basic operations included in a signature processing procedure, the subsystem interconnecting one or more basic operation execution units and a dispatcher that monitors operation states thereof and instructs to execute an operation; and

accept a plurality of signature generation requests or signature verification requests as a single input, and simultaneously process a plurality of requests in parallel.

### BRIEF DESCRIPTION OF DRAWINGS

FIG. 1 is a diagram showing an overall configuration of a signature generation device as a first exemplary embodiment;

FIG. 2 is a diagram showing a configuration of a random number generation subsystem according to the first exemplary embodiment;

FIG. 3 is a diagram showing a configuration of an elliptic curve operation subsystem in the first exemplary embodiment;

FIG. 4 is a diagram showing a configuration of a remainder operation subsystem in the first exemplary embodiment;

FIG. 5 is a diagram showing a configuration of a hash/integer operation subsystem in the first exemplary embodiment;

FIG. 6 is a flowchart showing operation of a dispatcher in the first exemplary embodiment;

FIG. 7 is a configuration diagram of a packet for use in communication between subsystems in the first exemplary embodiment;

FIG. 8 is a flowchart showing a group signature generation scheme in the first exemplary embodiment;

FIG. 9 is a graph showing specific measurement results of effects of the present invention;

FIG. 10 is a diagram showing a configuration of a signature verification device according to a third exemplary embodiment;

FIG. 11 is a flowchart showing a group signature verification algorithm in the third exemplary embodiment;

FIG. 12 is a conceptual diagram of a signature processing device for implementing the gist of the present invention without specifying an operation type;

FIG. 13 is a diagram showing a configuration of a signature processing device as a background art; and

FIG. 14 is a diagram showing a state where a number of signature processing devices corresponding to the number of requests are arranged in parallel.

### DESCRIPTION OF EMBODIMENTS

Next, exemplary embodiments of the present invention will be illustrated and described with reference to reference numerals denoting elements in the drawings.

### First Exemplary Embodiment

A first exemplary embodiment according to the present invention will be described.

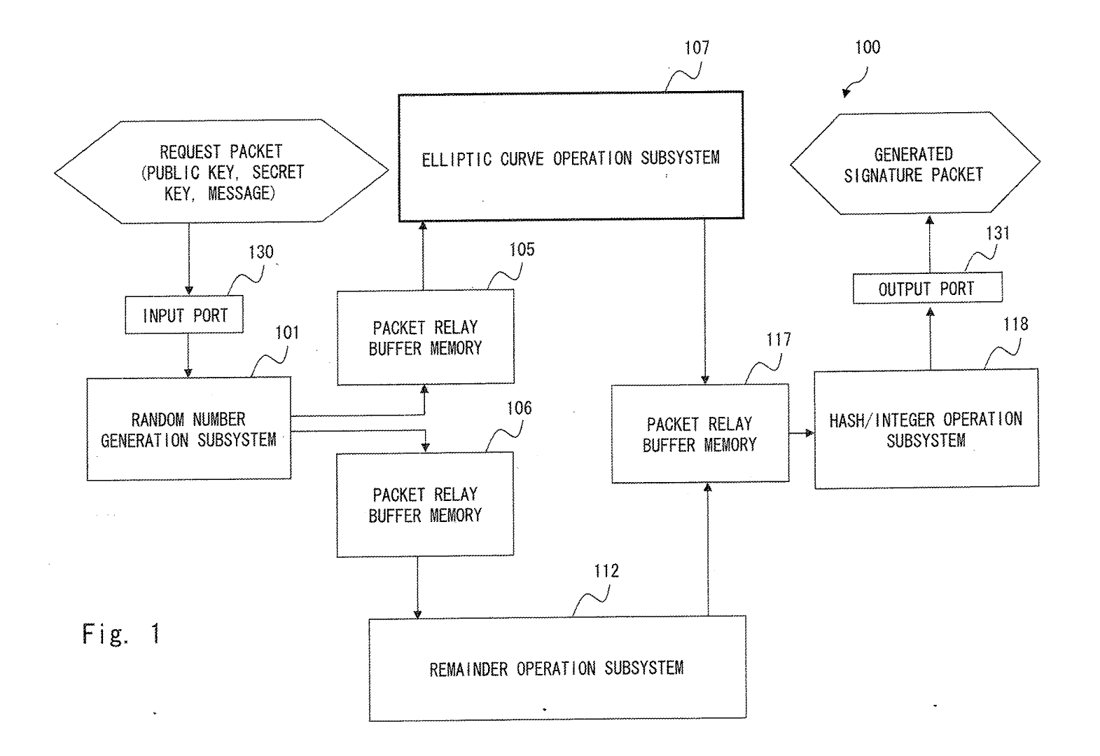

FIG. 1 shows a configuration of a signature generation device (signal processing device) according to the present invention.

A signature generation device 100 includes a random number generation subsystem 101, an elliptic curve operation subsystem 107, a remainder operation subsystem 112, a hash/integer operation subsystem 118, and packet relay buffer memories 105, 106, and 117.

In this case, the random number generation subsystem 101 and the elliptic curve operation subsystem 107 are connected through the packet relay buffer memory 105.

The random number generation subsystem 101 and the remainder operation subsystem 112 are connected through the packet relay buffer memory 106.

The operation results of the elliptic curve operation subsystem 107 and the remainder operation subsystem 112 are input to the hash/integer operation subsystem 118 through the packet relay buffer memory 117.

The signature generation device 100 includes one input port 130 and one output port 131. The signature generation device 100 sequentially accepts a plurality of request packets from the input port 130, and sequentially outputs final results (signature or verification) to the output port 131. Examples of the request packets include a public key of an opening manager, a secret key of a user, a public key of an issuance manager, a public key of a revocation manager, and a message.

The signature generation device 100 accepts the subsequent request even when processing for a single request is not completed. The accepted requests are sequentially sent from the preceding stage to the subsequent-stage subsystems 101, 107, 112, and 118 through the packet relay buffer memories 105, 106, and 117, to thereby proceed the arithmetic processing.

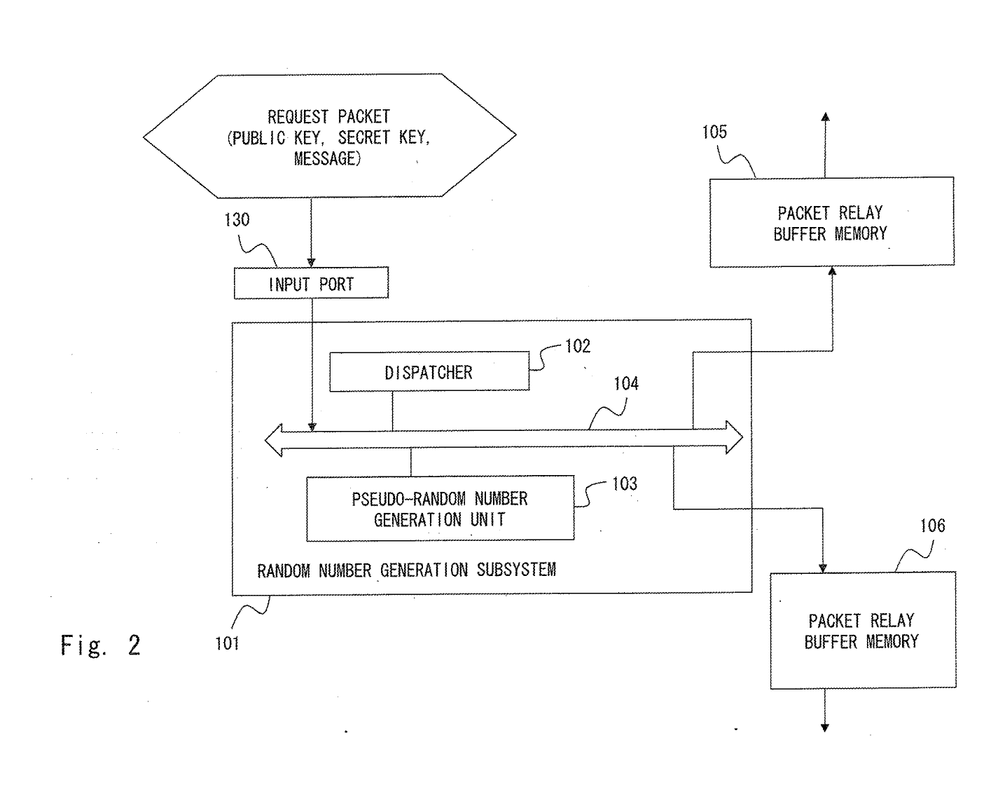

FIGS. 2 to 5 show the configurations of the subsystems. FIG. 2 shows the configuration of the random number generation subsystem 101.

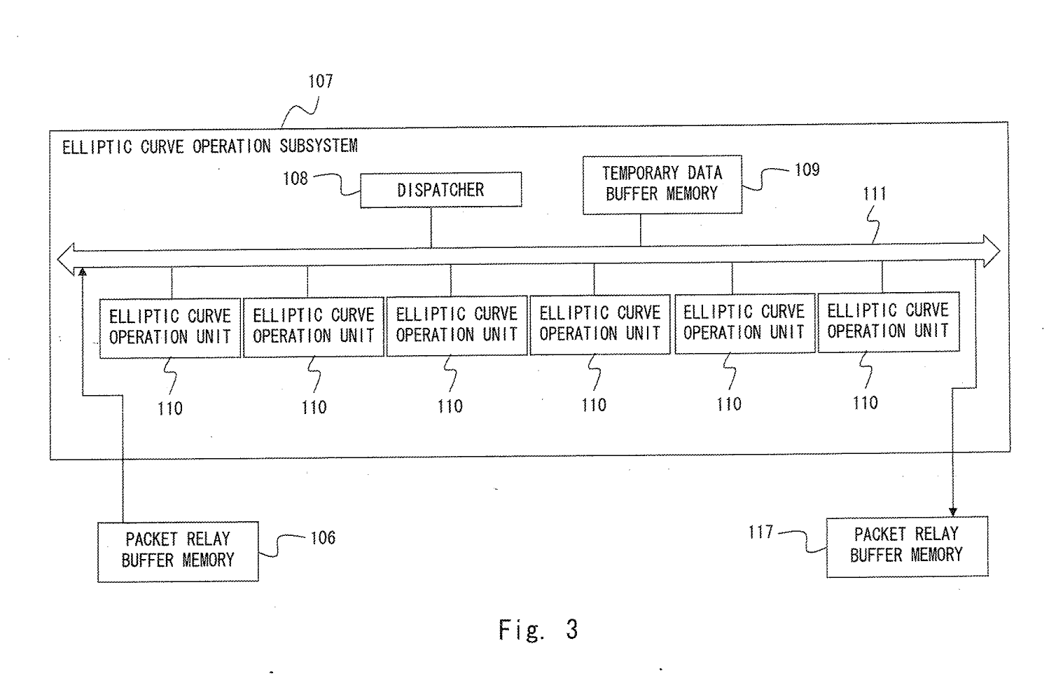

FIG. 3 shows the configuration of the elliptic curve operation subsystem 107.

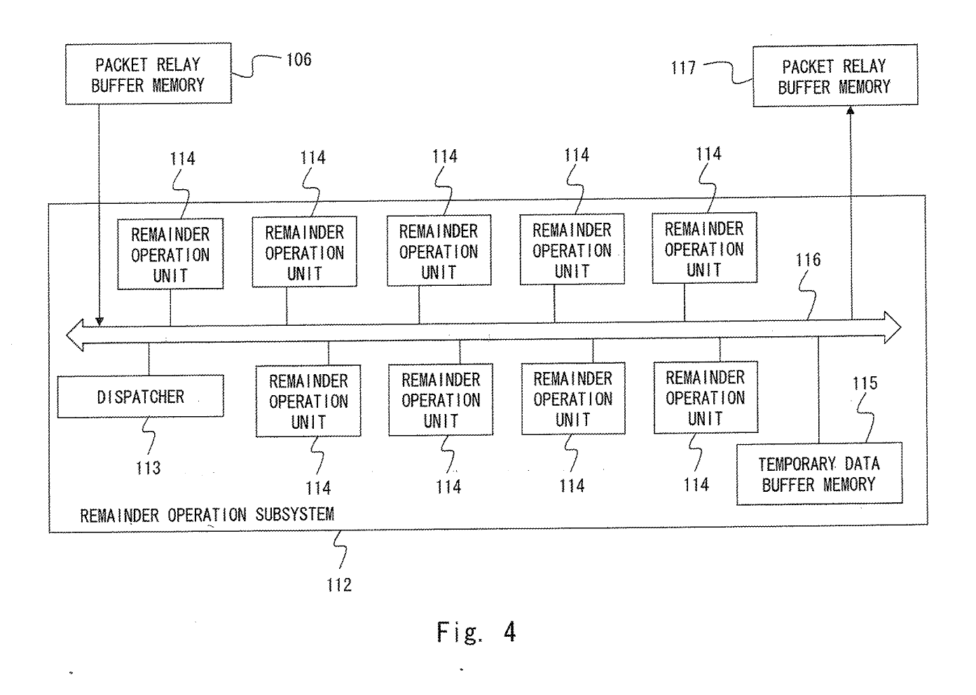

FIG. 4 shows the configuration of the remainder operation subsystem 112.

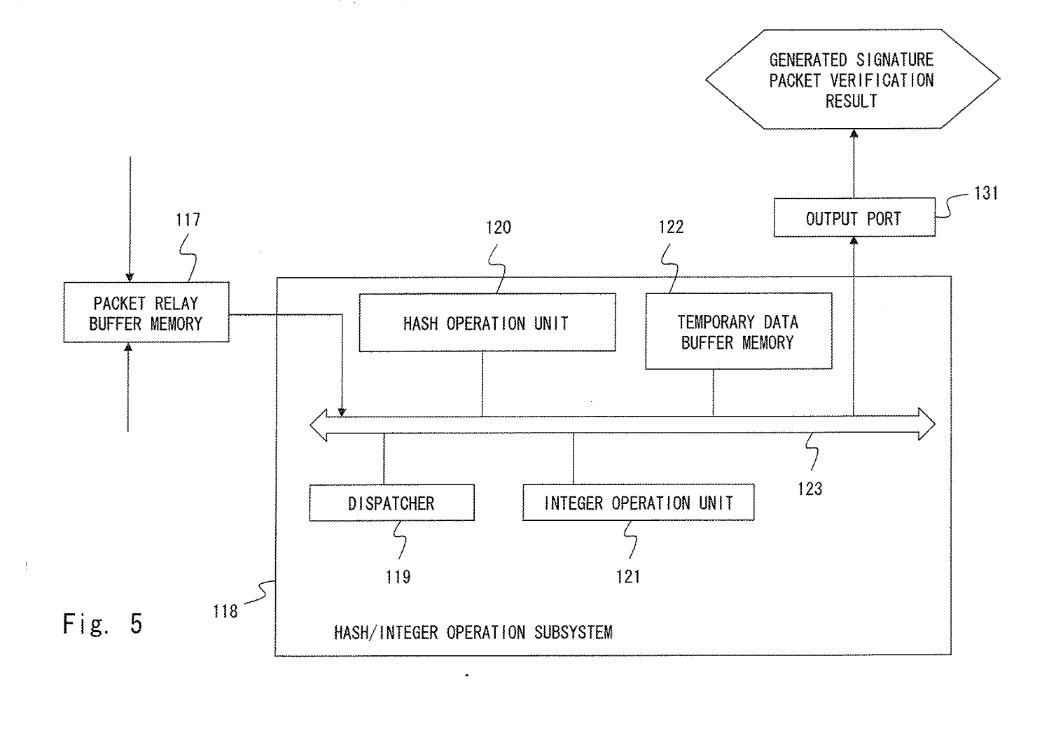

FIG. 5 shows the configuration of the hash/integer operation subsystem 118.

In this exemplary embodiment, the subsystems 101, 107, 112, and 118 include dispatchers 102, 108, 113, and 119, local buses 104, 111, 116, and 123, and one or more basic operation units 103, 110, 114, 120, and 121. The subsystems 101, 107, 112, and 118 may include local buffer memories 109, 115, and 122.

Specifically, as shown in FIG. 2, the random number generation subsystem 101 includes the dispatcher 102, the pseudo-random number generation unit 103, and the local bus 104.

In this case, only one pseudo-random number generation unit 103 is provided.

The random number generation subsystem 101 executes random number generation in a signature generation process.

As shown in FIG. 3, the elliptic curve operation subsystem 107 includes the dispatcher 108, the elliptic curve operation unit 110 serving as a basic operation unit, the temporary data buffer memory 109, and the local bus 111.

In this case, a plurality of elliptic curve operation units 110 is provided. In this exemplary embodiment, six elliptic curve operation units 110 are provided. The elliptic curve operation subsystem 107 executes an elliptic curve operation in the signature generation process.

As shown in FIG. 4, the remainder operation subsystem 112 includes the dispatcher 113, the remainder operation units 114 each serving as a basic operation unit, the temporary data buffer memory 115, and the local bus 116.

In this case, a plurality of remainder operation units 114 is provided. In this exemplary embodiment, nine remainder operation units 114 are provided.

The remainder operation subsystem 112 executes a remainder operation in the signature generation process.

The hash/integer operation subsystem 118 includes the dispatcher 119, the hash operation unit 120, the integer operation unit 121, the temporary data buffer memory 122, and the local bus 123.

In this case, one hash operation unit 120 and one integer operation unit 121 are provided.

The hash/integer operation subsystem 118 executes a hash operation and an integer operation during the signature generation and signature verification processes.

The group signature process for a single request includes a combination of a plurality of random number generation operations, a plurality of elliptic curve operation, a plurality of remainder operations, a plurality of hash operations, and a plurality of integer operations. In each arithmetic processing, the bit width of data to be handled varies even in the same type of arithmetic processing.

Since such a plurality of operations is combined, the operation time varies depending on the subsystem, and the time required for each internal basic operation is not constant. Accordingly, in terms of each subsystem, both an internal basic operation unit that is activated during a group signature operation and an internal basic operation unit that is deactivated during a group signature operation exist. An execution start timing of each operation is dynamically changed depending on the interval or number of incoming input packets, so the execution start timing cannot be statically determined.

For this reason, there is a need for a control mechanism that constantly monitors the input packets and operation execution status and instructs an unoccupied operation unit to execute an operation.

The dispatchers 102, 108, 113, and 119 have such a function.

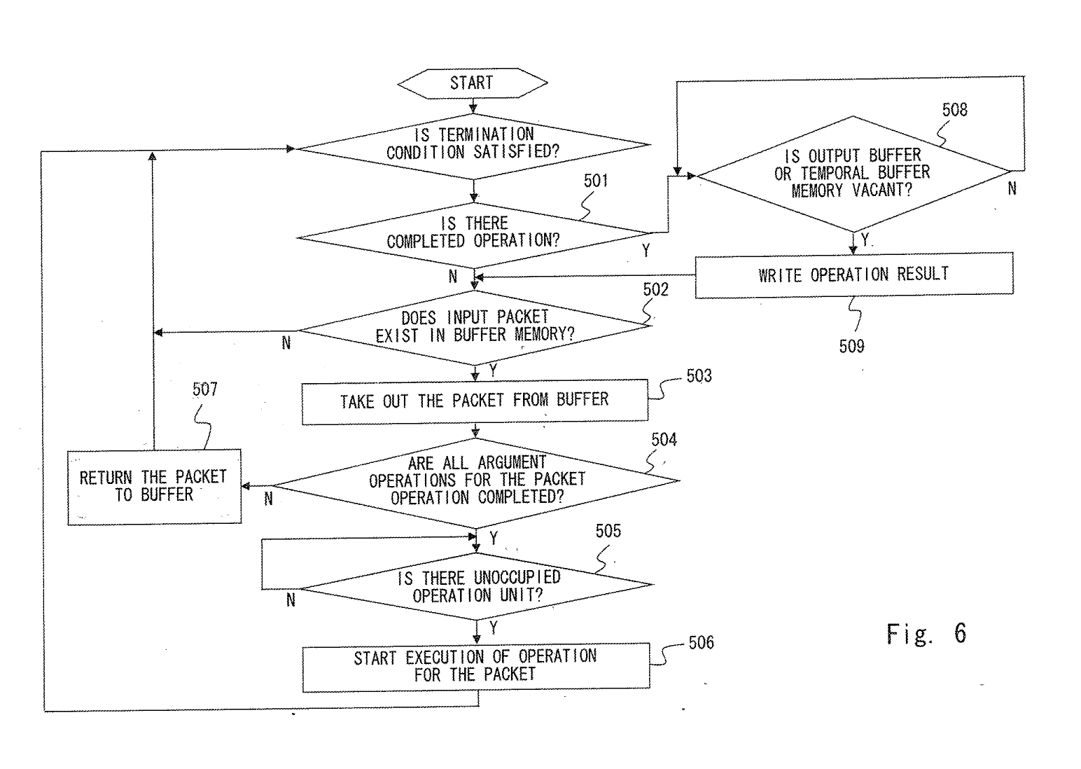

FIG. 6 is a flowchart showing the operation of each dispatcher.

Each dispatcher constantly monitors the number of packets in an input buffer and an output buffer, and the use status of each basic operation unit.

When an input packet exists in the input buffer (ST502), the dispatcher takes out the input packet (ST503) and determines whether all argument operations for executing the packet operation are completed (ST504). Specifically, the dispatcher monitors the dependency of operations. Then, upon receiving a certain request, the dispatcher confirms whether all operations necessary for a certain request are completed and data is prepared (ST504). When all argument operations for executing the packet operation are completed (ST504: YES), the dispatcher determines whether there is an unoccupied operation unit (ST505). If there is an operation unit that can execute the operation (ST505: YES), the dispatcher assigns arithmetic processing to the operation unit and causes the operation unit to start the operation (ST506).

After completion of the operation (ST501: YES), the dispatcher stores the result into the output buffer or the temporary data buffer (ST509).

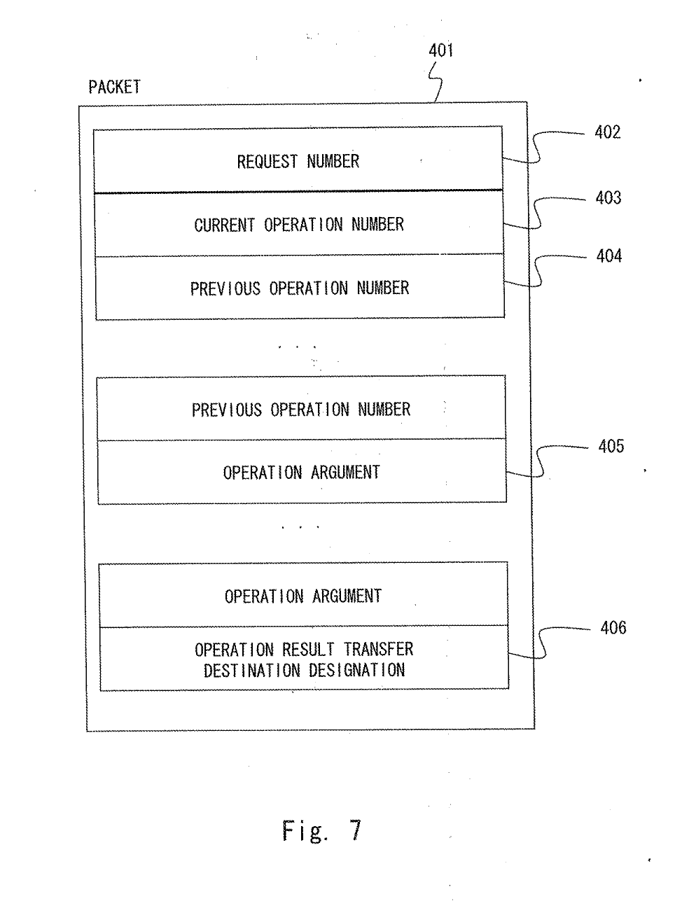

FIG. 7 is a configuration diagram of a packet for use in communication between subsystems.

A packet 401 specifies the content of arithmetic processing to be executed.

The packet 401 includes fields such as a request number 402 indicating which one of signature requests; a current operation number 403 indicating the operation number in the signature processing; a previous operation number 404 indicating one or more operations that should be completed before the current operation is started; an operation argument 405 representing a numerical value necessary for the operation; and a designation 406 indicating a location where the obtained operation result is transferred.

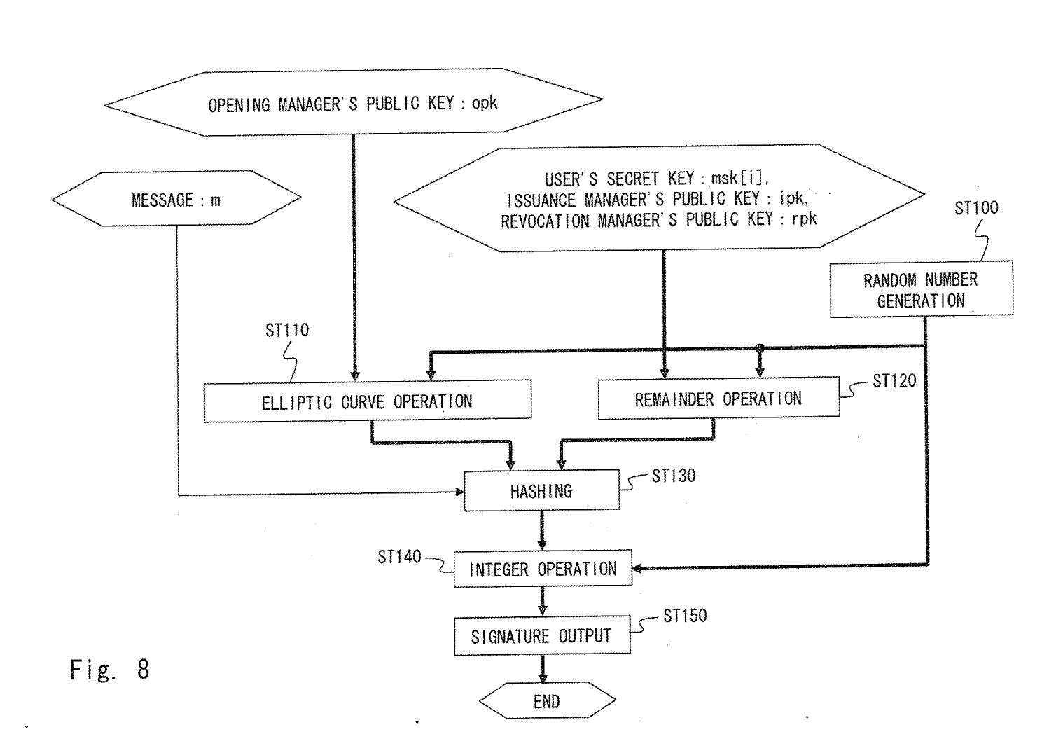

Referring next to FIG. 8, a group signature generation scheme will be described.

Note that a basic algorithm for group signatures is also disclosed in Non Patent Literature 1.

Four entities including a user, an issuance manager, a revocation manager, and an opening manager participate in the group signature scheme.

The user is a member of the group and performs signature generation and signature verification.

The issuance manager has an authority to add the user to the group.

The revocation manager has an authority to remove the user from the group.

The opening manager has an authority to specify a signer.

Here, for the following description, security parameters K=(K[n], K[1], K[e], K[e′], K[q], K[c], K[S]).

K[n], K[1], K[e], and K[e′] represent the bit numbers of parameters n, 1, e, and e′, respectively. That is, K[n], K[1], K[e], and K[e′] have the predetermined bit lengths K[n], K[1], K[e], and K[e′], respectively.

K[q] represents the bit length of a prime number q denoting the order of a finite group GG defined by an elliptic curve.

K[c] represents the bit length of a value c returned by to a hash function Hash applied to a bit sequence of arbitrary length.

K[S] represents such a bit length that when a random number r of bit-length |a|+K[S] for any integer a is selected, then a+r and a are statistically indistinguishable.

The group signature algorithm includes operations for the security parameters K, integer λ=K[n]+K[q]+K[S], a set of integer values A in a range from 0 (inclusive) to 2λ (exclusive), scalar multiplication on the elliptic curve, point addition on the elliptic curve, and point subtraction on the elliptic curve.

Hereinafter, “xs” represents scalar multiplication for a point on the elliptic curve; “+e” represents point addition on the elliptic curve;

and “−e” represents point subtraction on the elliptic curve.

Next, a description is given of a key pair (a public key and a secret key) owned by each of the user, the issuance manager, the revocation manager, and the opening manager of the group signature.

As shown in the following expressions, a key pair (ipk, isk) owned by the issuance manager of the group signature is determined based on prime numbers p[1] and p[2], which are cryptographically and mathematically secure and which have a bit length of K[n]/2; the product n=p[1]p[2] of these prime numbers; and elements a[0], a[1], and a[2] of a cyclic subgroup QR(n) with respect to the product n.

Note that ipk represents a public key of the issuance manager, and isk represents a secret key of the issuance manager.
issuance manager's public key ipk=(n, a[0], a[1], a[2]);
issuance manager's secret key isk=(p[1], p[2])

As shown in the following expressions, a key pair (opk, osk) owned by the opening manager of the group signature is determined based on elements y[1] and y[2] of a prime number q-modulo finite field Zq; an element G of the finite group GG; H[1]=y[1]xsG, and H[2]=y[2]xsG.

Note that opk represents the public key of the opening manager, and osk represents the secret key of the opening manager.
opening manager's public key opk=(q, G, H[1], H[2]);
opening manager's secret key osk=(y[1], y[2])

As shown in the following expressions, a key pair (rpk, rsk) owned by the revocation manager of the group signature is determined based on safe prime numbers 1[1] and 1[2] of a bit length K[1]/2; the product 1=1[1]1[2] of these prime numbers; and elements b and w of a cyclic subgroup QR(1) with respect to the product 1.

Note that rpk represents the public key of the revocation manager, and rsk represents the secret key of the revocation manager.
revocation manager's public key rpk=(1, b, w);
revocation manager's secret key rsk=(1[1], 1[2])

As shown in the following expressions, a key pair (mpk, msk) owned by an i-th user of the group signature is determined based on an element x[i] of the A; and A[i], B[i], e[i], and e′[i] which satisfy h[i]=x[i]xsG, B[i]=b1/e′[i](mod 1), e[i]=2K[e]+e′[i], and a[0]a[1]x[i]≡A[i]e[i](mod n).

Note that mpk[i] represents the public key of the i-th user, and msk[i] represents the secret key of the i-th user.
i-th user's public key mpk[i]=(h[i], A[i], e′[i], B[i]);
i-th user's secret key msk[i]=x[i]

Referring to FIG. 8, the case where the i-th user generates a signature for a message m will be described.

In this case, a signature is generated in the following manner by using, as inputs, the message m, the public key opk of the opening manager, the secret key msk[i] of the user, the public key ipk of the issuance manager, and the public key rpk of the revocation manager.

In step ST100, the random number generation subsystem 101 generates random numbers.

Specifically, ρ[E], ρ[m], ρ[r], μ[x], μ[s], μ[t], and μ[E] are randomly selected as follows.
ρ[E]: an element of the above-mentioned finite field Zq
ρ[m]: a bit sequence of bit length K[n]/2
ρ[r]: a bit sequence of bit length K[1]/2
μ[x]: a bit sequence of bit length λ+K[c]+K[S]
μ[s]: a bit sequence of bit length K[e]+K[n]/2+K[c]+K[S]
μ[e′]: a bit sequence of bit length K[c′]+K[c]+K[S]
μ[t]: a bit sequence of bit length K[e′]+K[1]/2+K[c]+K[S]
μ[E]: an element of the above-mentioned finite field Zq

In step ST110, the elliptic curve operation unit 110 of the elliptic curve operation subsystem 107 executes a plurality of elliptic curve operations to obtain E[0], E[1], E[2], E, and V[ComCipher] in the following manner by using the public key of the opening manager and random numbers.
E[0]=ρ[E]xsG
E[1]=h[i]+eρ[E]xsH[1]
E[2]=h[i]+eρ[E]xsH[2]
E=(E[0],E[1],E[2])
V[ComCipher]=(μt[E]xsG, μ[x]xsG+eμ[E]xsH[1], μ[x]xsG+eμ[E]xsH[2])

At this time, according to the function of the dispatcher 108, the status of each of the six elliptic curve operation units 110 is monitored, and data is sequentially sent to unoccupied elliptic curve operation units 110 to thereby advance the operation efficiently.

Note that an operation “Z=(W, X, Y)” indicates that an operation W, an operation X, and an operation Y are separately carried out and then put together (tuple calculation).

In step ST120, the remainder operation units 114 of the remainder operation subsystem 112 execute a plurality of remainder operations to obtain A[COM], B[COM], V[ComMPK], and V[ComREV]in the following manner by using the public key of the issuance manager and the public key of the revocation manager.
A[COM]=A[i]a[2]ρ[m] (mod n)
B[COM]=B[i]wρ[r] (mod 1)
V[ComMPK]=a[1]μ[x]a[2]μ[s]A[COM]−μ[e′] (mod n)
V[ComREV]=wμ[t]B[COM]−μ[e′] (mod 1)

At this time, according to the function of the dispatcher 113, the status of each of the nine remainder operation units 114 is monitored, and data is sequentially sent to unoccupied remainder operation units 114 to thereby advance the operation efficiently.

The remainder operations are executed in parallel with the elliptic curve operations described above.

At this time, the latency of each elliptic curve operation is designed to be substantially the same as the latency of each remainder operation. The elliptic curve operation result and the remainder operation result for a single request are output to the packet relay buffer memory 117 at substantially the same time. This will be described in detail later.

In step ST130, the hash operation unit 120 obtains a hash c by the following operation using the operation result of the elliptic curve operation, the operation result of the remainder operation, and the message m.
c=Hash (K, ipk, opk, rpk, E, A[COM], B[COM], V[ComCipher], V[ComMPK], V[ComRev], m)

In step ST140, the integer operation unit 121 executes integer operations to obtain τ[x], τ[s], τ[t], τ[e′], and τ[E] by the following operations using the operation result of the hash operation and random numbers.
τ[x]=cx[i]+μ[x] (mod q)
τ[s]=ce[i]ρ[m]+μs] (mod q)
τ[t]=ce′[i]ρ[r]+μ[t] (mod q)
τ[e′=ce′[i]μ[e′] (mod q)
τ[E]=cρ[E]+μ[E] (mod q)

In step ST150, a signature (E, A[COM], B[COM], c, τ[x], τ[s], τ[t], τ[e], τ[E]) is output. The signature is generated in the manner as described above.

In this exemplary embodiment, the above-mentioned configuration allows the unoccupied operation units to be allocated to other request processing immediately, thereby remarkably reducing the vacant time of each operation unit. This is why an increase in processing time is suppressed.

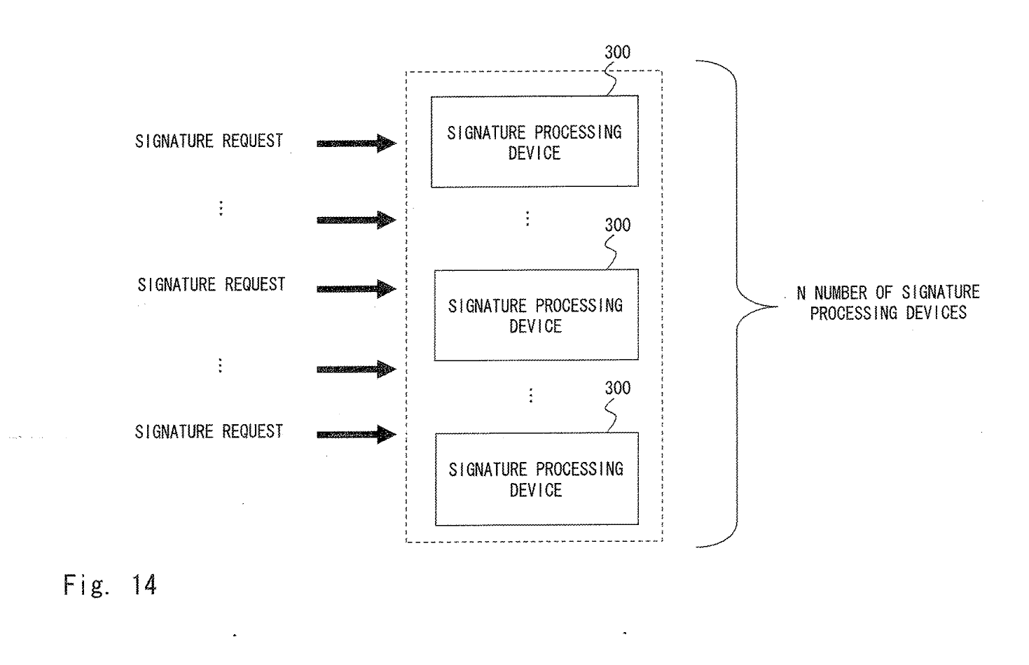

For example, in the case where the signature processing devices corresponding to the number of requests are arranged as shown in FIG. 14 which is described in the “Background Art” section, one signature processing device can execute only an operation for a single request. Accordingly, even if the operation units (for example, the elliptic curve operation unit and the remainder operation unit) of the neighboring signature processing device are unoccupied, the unoccupied operation units cannot be used to process the request. Thus, in the configuration shown in FIG. 14, the operating rate is low for the entire circuit size, and the arithmetic processing speed is low.

In this regard, according to the configuration of this exemplary embodiment, the overall circuit size can be reduced and the arithmetic processing for a plurality of requests can be carried out at high speed.

How to set the number of basic operation units that constitute each subsystem will now be described.

The number of basic operation units within each subsystem is not necessarily the same as the number of requests to be processed simultaneously.

For example, even in the case of processing six requests simultaneously, each subsystem does not necessarily have six basic operation units.

Also the operation execution speed varies depending on the type of the basic operation. Accordingly, the number of basic operation units may be designed such that the number of basic operation units for basic operations to be processed at low speed is increased and the number of basic operation units for basic operations to be processed at high speed is reduced. When the latencies of the subsystems are at substantially the same, the highest performance can be achieved with the smallest number of devices.

More specifically, the remainder operation that most limits the speed of the entire signature processing is 10 times or more slower than the other operations.

In the signature processing, several remainder operations are used, and there is about a 10-fold difference between the operation speeds due to a difference in data bit width.

For this reason, in the remainder operation subsystem 112, a number of remainder operation units 114 which are more than the number of basic operation units of other subsystems are required. For example, in this exemplary embodiment, to set the latencies of the subsystems to be the same, the number of the pseudo-random number generation units 103 of the random number generation subsystem 101 is set to one; the number of the elliptic curve operation subsystems is set to six; the number of the remainder operation units 114 is set to nine; and the number of each of the hash operation units 120 and the integer operation units 121 is set to one.

In the case of processing a single request, a slow remainder operation and a fast remainder operation are required. While one remainder operation unit 114 is executing a slow remainder operation, another remainder operation unit 114 can execute a faster remainder operation a plurality of times. Accordingly, the number of remainder operation unit may be smaller than the number of remainder operations to be carried out in the signature processing.

Even when it takes a lot of time to carry out a remainder operation for a certain request, a remainder operation for another request can be started if there is an unoccupied remainder operation unit.

In this manner, the use efficiency of each operation unit is kept at approximately 100%, which makes it possible to process as many requests as possible with a small number of operation units.

In addition, since operations other than the remainder operation are carried out at relatively low speed, all the necessary operations can be completed before the completion of the remainder operation, with a small number of operation units. Thus, even when the number of the elliptic curve operation units is reduced to six and the number of other basic operation units is reduced to one, the performance of the overall signature processing is not lowered. As a result, according to this exemplary embodiment, the same processing performance can be achieved with a half circuit size as compared with the case where a plurality of signature circuits is simply arranged.

Further, since the power consumption is substantially proportional to the circuit size, the power consumption in this exemplary embodiment can be suppressed to about a half as compared with the case where a plurality of signature circuits is simply arranged.

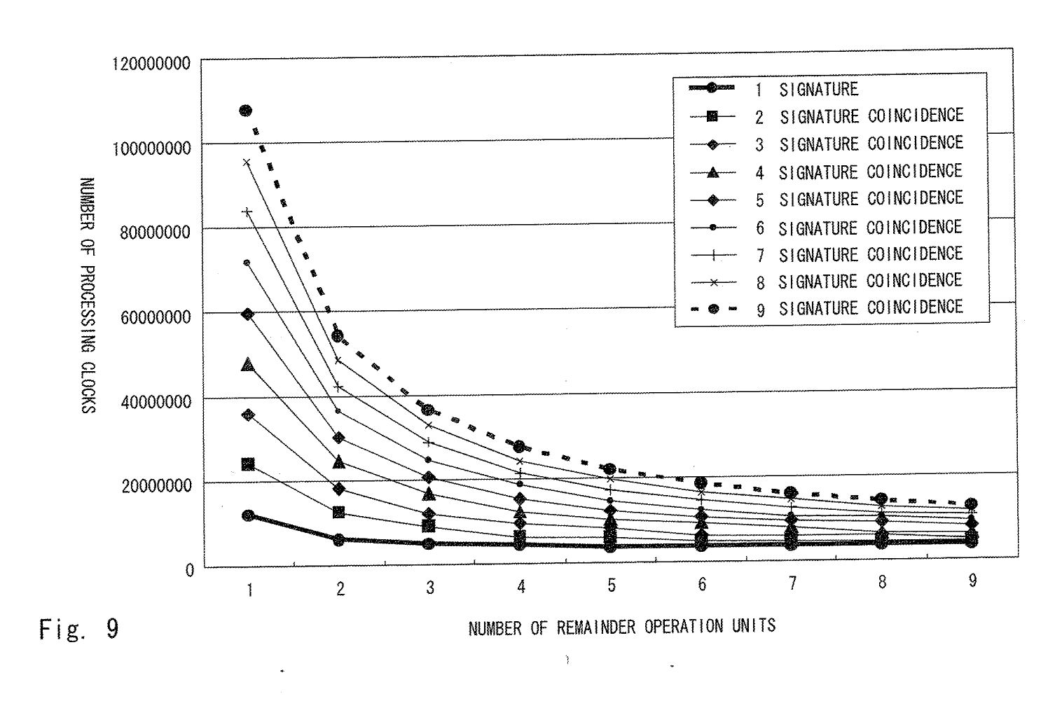

FIG. 9 is a graph showing specific measurement results of effects of the present invention.

In the configuration of the first exemplary embodiment, the number of the elliptic curve operation units is fixed to six; the number of the pseudo-random number generation units is fixed to one; the number of the hash operation units is fixed to one; the number of the integer operation units is fixed to one; and the number of the remainder operation units that most limit the speed is changed from one to nine. Then, the relationship between the number of requests that require simultaneous processing and the time required to complete processing for all the requests is measured and plotted on a graph.

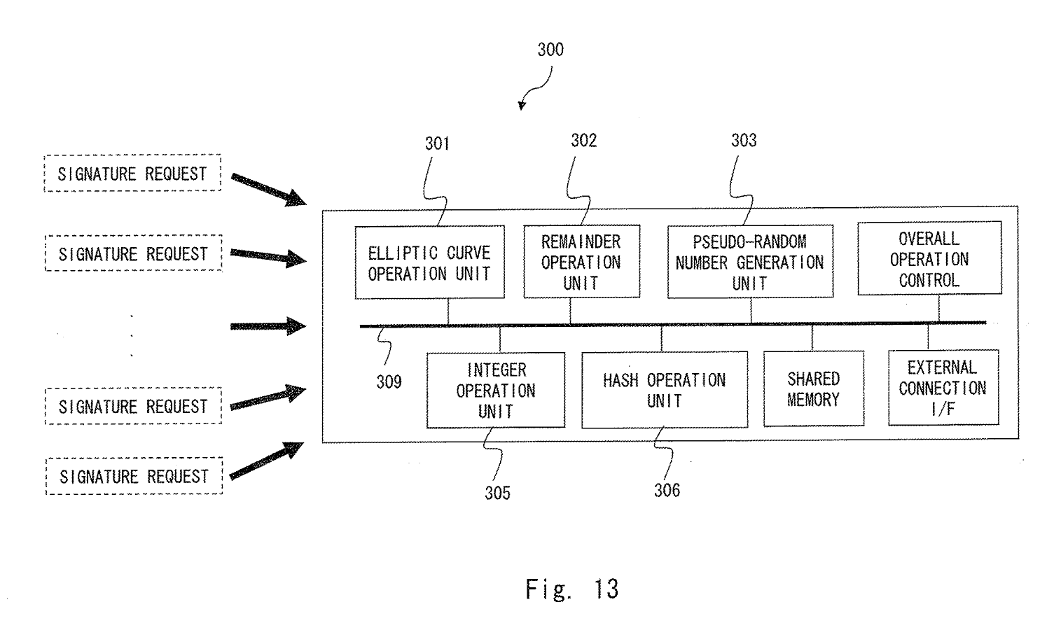

When the number of the remainder operation units is one, the processing speed and the number of the signature circuits that process a single request shown in FIG. 13 are substantially the same. In this case, if the number of requests increases nine-fold, the processing time increases nine-fold. To reduce the processing time in this configuration, it is necessary to arrange a number of signature circuits corresponding to the number of requests.

On the other hand, as the number of remainder operation units is increased, the increase in the processing time is not nine-fold but about four-fold even when the number of requests increases nine-fold. Thus, the processing time can be suppressed to about the same level as the processing time shown in FIG. 1. As a result, the same processing speed can be achieved with a circuit size half or smaller than the circuit size shown in FIG. 14.

### Second Exemplary Embodiment

The first exemplary embodiment described above illustrates the configuration in which the signature generation process is executed using dedicated operation circuits. Specifically, dedicated circuits for executing and processing each basic operation are used.

On the other hand, each basic operation for generating a signature may be executed using one or more CPUs (Central Processing Units) that execute software, as a matter of course. In this case, the signature generation device includes at least a plurality of elliptic curve operation processor cores that execute an elliptic curve operation; a plurality of remainder operation processor cores that execute a remainder operation; a plurality of integer operation processor cores that execute an integer operation; a random number generation processor core that executes random number generation; a hash operation processor core that executes a hash operation; a shared memory that relays packets; and a plurality of processor cores that execute a dispatching process. The number of processor cores that execute each basic operation is appropriately designed such that nine remainder operation processor cores are provided and six elliptic curve operation processor cores are provided, for example.

Each processor core that executes the dispatching process monitors the status of each of the shared memory and the processor cores that execute the basic operation. When a packet for requesting an operation is stored in the shared memory, the processor core causes the unoccupied processor in charge of the basic operation to start the operation.

This allows the process to be executed in a similar manner to the case where the signature circuits are configured using the dedicated circuits.

In the case where a multicore is configured using a plurality of CPUs, part of basic operation execution units may be configured using CPUs, instead of configuring all the basic operation execution units using CPUs.

Further, a signature processing program for causing CPUs to function as operation units may be provided in a form recorded in a computer-readable recording medium.

### Third Exemplary Embodiment

While the above-mentioned first and second exemplary embodiments illustrate exemplary signature generation devices, the present invention can also be applied to a signature verification device.

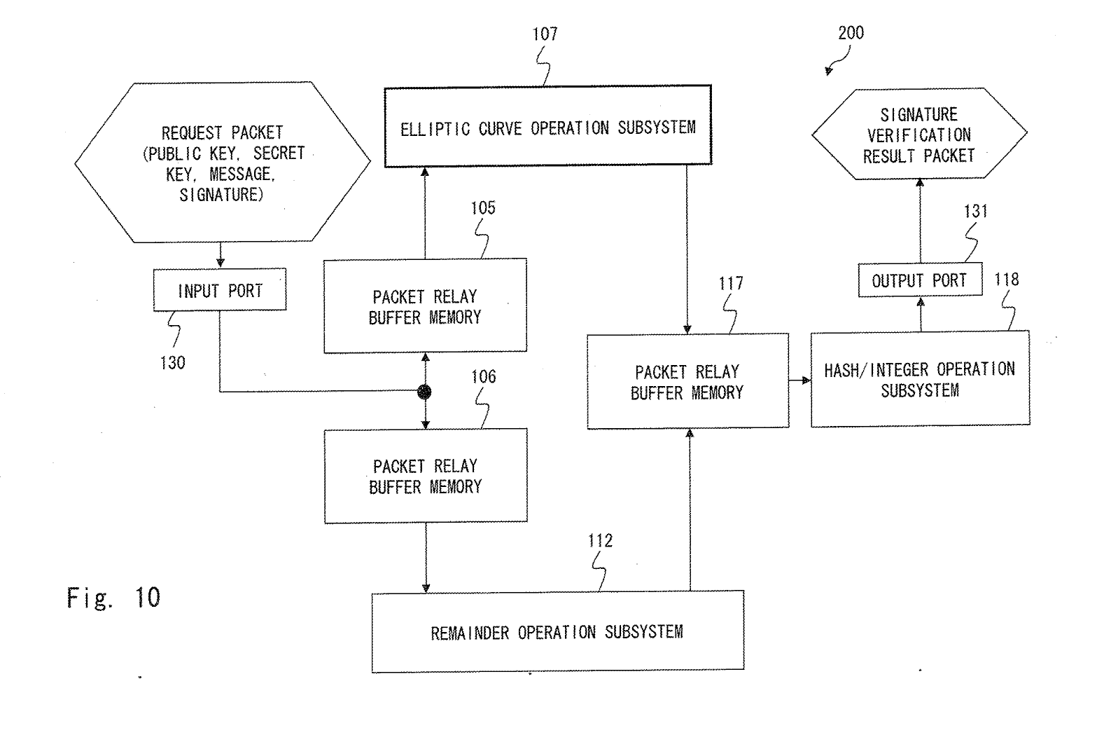

FIG. 10 shows a configuration of a signature verification device 200 according to the present invention.

The signature verification device 200 may have a configuration similar to that of the signature generation device 100, except for the random number generation. Accordingly, the elements identical to those of the first exemplary embodiment are denoted by the same reference numerals, and the description thereof is omitted.

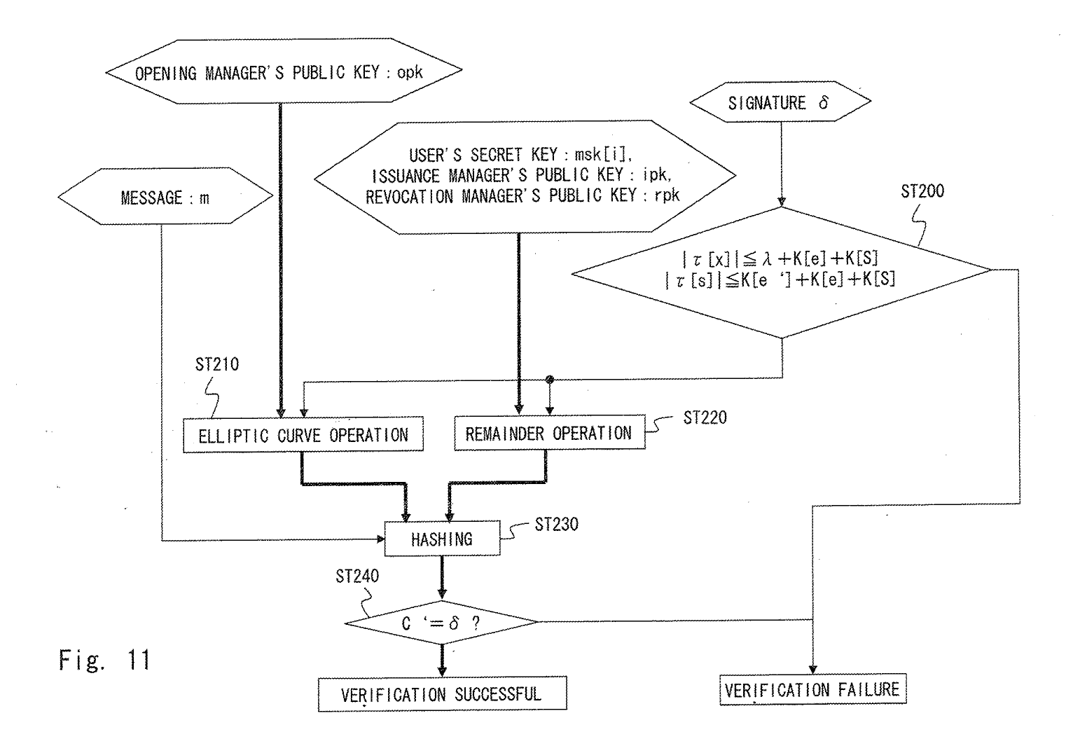

FIG. 11 is a flowchart showing a signature verification algorithm.

The signature verification algorithm has substantially the same data flow as that of the signature generation, except for the random number generation.

In the signature verification algorithm, a signature is verified in the following manner by using, as inputs, the public key ipk of the issuance manager, the public key rpk of the revocation manager, the public key opk of the opening manager, the message m, and a signature δ.

In step ST200, it is checked whether |τ[x]|≦λ+K[e]+K[S] and |τ[s]|≦K[e′+K[e]+K[S] are satisfied. If the both expressions are not satisfied, a verification failure is returned.

In step ST210, V′[ComCipher]=(τ[E]xsG−e[c]xsE[0], τ[x]xsG+eτ[E]xsH[1]−e[c]xsE[1], τ[x]xsG+eτ[E]xsH[2]−e[c]xsE[2]) is calculated by an elliptic curve operation.

In step ST220, V′[ComMPK]=a[0]ca[1]τ[x]a[2]τ[s]A[COM]−(e2K[e]+τ[e′])(mod n) and V′[ComREV]=beωτ[t]B[COM]−τ[e′](mod 1) are calculated by a remainder operation.

In step ST230, a hash c′ is obtained as follows by a hash operation.
c′=Hash (K, ipk, opk, rpk, E, A[COM], B[COM], V′[ComCipher], V′[ComMPK], V′[ComRev], m)

In step ST240, if hash c′=signature δ holds, a verification success is returned, and if hash c′=signature δ does not hold, a verification failure is returned

The signature verification is carried out in this manner.

Also in such a signature verification device, the same operation and effect as those of the first exemplary embodiment are obtained.

The signature verification device can also be configured using one or more CPUs (Central Processing Units) that execute software, as a matter of course.

Note that the present invention is not limited to the exemplary embodiments described above, and can be modified as appropriate without departing from the scope of the present invention.

The number and the like of the circuit units or processor cores that execute basic operations are not limited to those illustrated above, as a matter of course.

For example, the number of the pseudo-random number generation units of the random number generation subsystem is not limited to one, but may be two or more.

The number of the elliptic curve units of the elliptic curve operation subsystem is not limited six, but may be more than six or less than six.

The number of the remainder operation units of the remainder operation subsystem is not limited to nine, but may be more than nine or less than nine.

The number of the hash operation units and integer operation units of the hash/integer operation unit is not limited to one, but may be two or more.

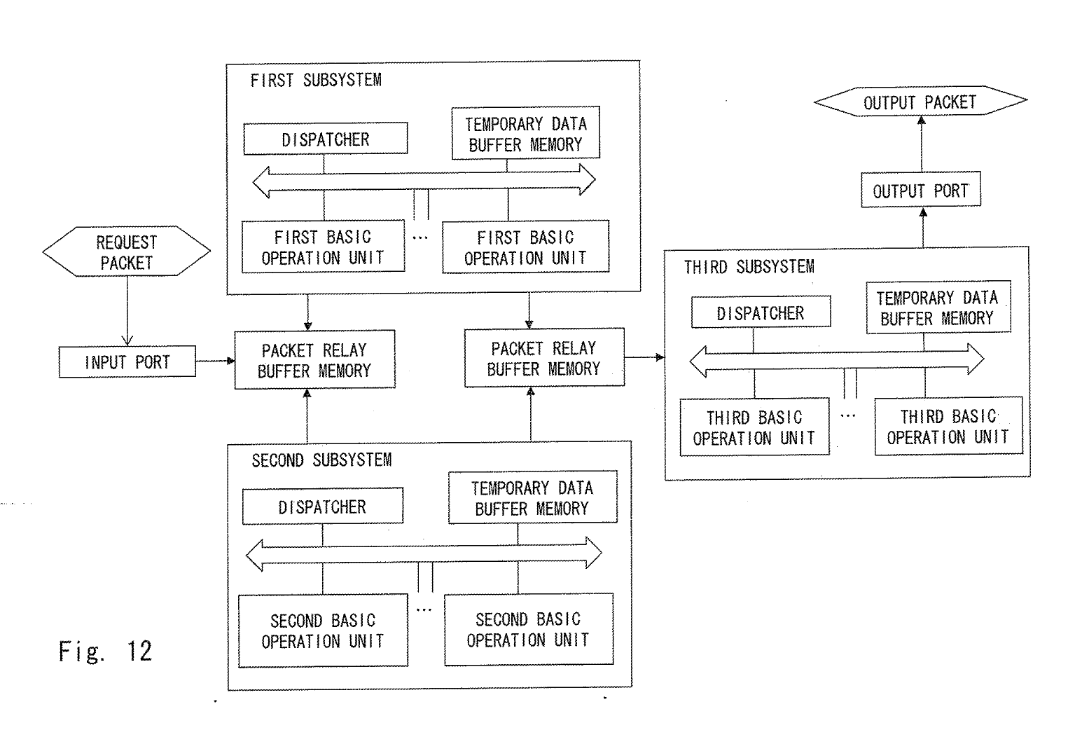

Moreover, the present invention is not limited to a signature processing device for generating or verifying a group signature. The present invention can also be applied to other devices that execute security-related composite operations. FIG. 12 is a conceptual diagram of a signature processing device for implementing the scope of the present invention without specifying the operation type.

This application is based upon and claims the benefit of priority from Japanese patent application No. 2010-243321, filed on Oct. 29, 2010, the disclosure of which is incorporated herein in its entirety by reference.

The whole or part of the exemplary embodiments disclosed above can be described as, but not limited to, the following supplementary notes.

### (Supplementary Note 1)

A signature processing device that configures subsystems for each type of basic operations included in a signature processing procedure, each of the subsystems interconnecting one or more basic operation execution units and a dispatcher that monitors operation states thereof and instructs to execute an operation, wherein the plurality of subsystems is connected through a buffer memory that relays an operation request.

### (Supplementary Note 2)

The signature processing device according to Supplementary note 1, wherein

a plurality of signature generation requests or signature verification requests is accepted as a single input, and a plurality of requests is simultaneously processed in parallel, and

the subsystems assign operations in different requests to respective basic operation units and simultaneously execute the operations without being exclusively occupied with a single request.

### (Supplementary Note 3)

The signature processing device according to Supplementary note 1 or 2, comprising, as the subsystems, a remainder operation subsystem, an elliptic curve operation subsystem, and an integer operation/hash operation subsystem, wherein

the remainder operation subsystem includes a plurality of remainder operation units that execute a remainder operation, and a dispatcher that controls the remainder operation units, and

the elliptic curve operation subsystem includes a plurality of elliptic curve operation units that execute an elliptic curve operation, and a dispatcher that controls the elliptic curve operation units, and

the integer operation/hash operation subsystem includes one or more hash operation units that execute a hash operation, one or more integer operation units that execute an integer operation, and a dispatcher that controls the hash operation units and the integer operation units.

### (Supplementary Note 4)

The signature processing device according to Supplementary note 3, further comprising a random number generation operation subsystem as the subsystem,

wherein the random number generation operation subsystem includes one or more random number generation units that execute a random number generation operation, and a dispatcher that controls the one or more random number generation units.

### (Supplementary Note 5)

The signature processing device according to Supplementary note 4, wherein the number of the random number generation units of the random number generation operation subsystem is one.

### (Supplementary Note 6)

The signature processing device according to any one of Supplementary notes 3 to 5, wherein the number of the elliptic curve operation units of the elliptic curve operation subsystem is equal to or less than the number of the remainder operation units of the elliptic curve operation subsystem.

### (Supplementary Note 7)

The signature processing device according to any one of Supplementary notes 3 to 6, wherein the number of the integer operation units of the integer operation/hash operation subsystem is one.

### (Supplementary Note 8)

The signature processing device according to any one of Supplementary notes 3 to 7, wherein the number of the hash operation units of the integer operation/hash operation subsystem is one.

### (Supplementary Note 9)

The signature processing device according to any one of Supplementary notes 1 to 9, wherein part or all of the basic operation execution units and part or all of the dispatchers are configured using a processor core.

### (Supplementary Note 10)

The signature processing device according to any one of Supplementary notes 1 to 9, wherein the signature processing device is one of a group signature generation device that generates a group signature, and a group signature verification device that verifies a group signature.

### (Supplementary Note 11)

A signature processing method comprising: simultaneously executing, by one or more basic operation execution units, a plurality of basic operations included in a signature processing procedure;

monitoring an operation state and sequentially instructing acceptable basic operation execution units to sequentially execute operations; and

assigning operations in different requests to the respective basic operation units and causing the basic operation units to simultaneously execute the operations without being occupied with a single request.

### (Supplementary Note 12)

A signature processing program that causes a computer including a plurality of processors to:

function as a subsystem for each type of basic operations included in a signature processing procedure, the subsystem interconnecting one or more basic operation execution units and a dispatcher that monitors operation states thereof and instructs to execute an operation; and

accept a plurality of signature generation requests or signature verification requests as a single input, and simultaneously process a plurality of requests in parallel.

### (Supplementary Note 13)

A computer-readable recording medium storing the signature processing program according to Supplementary note 12.

### REFERENCE SIGNS LIST

100 . . . SIGNATURE GENERATION DEVICE, 101 . . . RANDOM NUMBER GENERATION SUBSYSTEM, 102 . . . DISPATCHER, 103 . . . PSEUDO-RANDOM NUMBER GENERATION UNIT, 104 . . . LOCAL BUS, 105 . . . PACKET RELAY BUFFER MEMORY, 106 . . . PACKET RELAY BUFFER MEMORY, 107 . . . ELLIPTIC CURVE OPERATION SUBSYSTEM, 108 . . . DISPATCHER, 109 . . . TEMPORARY DATA BUFFER MEMORY, 110 . . . ELLIPTIC CURVE OPERATION UNIT, 111 . . . LOCAL BUS, 112 . . . REMAINDER OPERATION SUBSYSTEM, 113 . . . DISPATCHER, 114 . . . REMAINDER OPERATION UNIT, 115 . . . TEMPORARY DATA BUFFER MEMORY, 116 . . . LOCAL BUS, 117 . . . PACKET RELAY BUFFER MEMORY, 118 . . . HASH/INTEGER OPERATION SUBSYSTEM, 119 . . . DISPATCHER, 120 . . . HASH OPERATION UNIT, 121 . . . INTEGER OPERATION UNIT, 122 . . . TEMPORARY DATA BUFFER MEMORY, 123 . . . LOCAL BUS, 130 . . . INPUT PORT, 131 . . . OUTPUT PORT, 301 . . . ELLIPTIC CURVE OPERATION UNIT, 302 . . . REMAINDER OPERATION UNIT, 303 . . . PSEUDO-RANDOM NUMBER GENERATION UNIT, 305 . . . INTEGER OPERATION UNIT, 306 . . . HASH OPERATION UNIT, 401 . . . PACKET, 402 . . . REQUEST NUMBER, 403 . . . CURRENT OPERATION NUMBER, 404 . . . PREVIOUS OPERATION NUMBER, 405 . . . OPERATION ARGUMENT, 406 . . . TRANSFER DESTINATION DESIGNATION.

1-10. (canceled)

11. A signature processing device comprising a plurality of subsystems that are prepared for each type of basic operations included in a signature processing procedure, and
each of the subsystems comprising one or more basic operation execution means and a dispatcher that monitors operation states of the basic operation execution means and instructs to execute an operation to the basic operation execution means,
wherein the subsystems are connected through a buffer memory that relays an operation request.

12. The signature processing device according to claim 11, wherein
a plurality of signature generation requests or signature verification requests is accepted as a single input, and a plurality of requests is simultaneously processed in parallel, and
the subsystems assign operations in different requests to respective basic operation units and simultaneously execute the operations without being exclusively occupied with a single request.

13. The signature processing device according to claim 11, comprising, as the subsystems, a remainder operation subsystem, an elliptic curve operation subsystem, and an integer operation/hash operation subsystem, wherein
the remainder operation subsystem includes a plurality of remainder operation means for executing a remainder operation, and a dispatcher that controls the remainder operation means,
the elliptic curve operation subsystem includes a plurality of elliptic curve operation means for executing an elliptic curve operation, and a dispatcher that controls the elliptic curve operation means, and
the integer operation/hash operation subsystem includes one or more hash operation means for executing a hash operation, one or more integer operation means for executing an integer operation, and a dispatcher that controls the hash operation means and the arithmetic operation means.

14. The signature processing device according to claim 13, further comprising a random number generation operation subsystem as the subsystem,
wherein the random number generation operation subsystem includes one or more random number generation means for executing a random number generation operation, and a dispatcher that controls the random number generation means.

15. The signal processing device according to claim 14, wherein the number of the random number generation means of the random number generation operation subsystem is one.

16. The signature processing device according to claim 13, wherein the number of the elliptic curve operation means of the elliptic curve operation subsystem is equal to or less than the number of the remainder operation means of the remainder operation subsystem.

17. The signature processing device according to claim 13, wherein the number of the integer operation means of the integer operation/hash operation subsystem is one.

18. The signature processing device according to claim 13, wherein the number of the hash operation means of the integer operation/hash operation subsystem is one.

19. A signature processing method comprising:
simultaneously executing, by one or more basic operation execution means, basic operations included in a signature processing procedure;
monitoring an operation state and instructing available basic operation execution means to execute operations sequentially; and
assigning operations in different requests to the respective basic operation means and causing the basic operation means to simultaneously execute the operations without being occupied with a single request.

20. A recording medium storing a signature processing program that causes a computer including a plurality of processors to:
function as a plurality of subsystems for each type of basic operations included in a signature processing procedure, each of the subsystem comprising one or more basic operation execution means and a dispatcher that monitors operation states of the basic operation execution means and instructs to execute an operation to the basic operation execution means,
accept a plurality of signature generation requests or signature verification requests as a single input, and simultaneously process a plurality of requests in parallel.
